(19) United States
(12) Patent Application Publication
(10) Pub. No.: US 2007/0136055 A1
(43) Pub. Date: Jun. 14, 2007

(54) System for data communication over voice band robust to noise

(76) Inventor: Phillip A. Hetherington, Port Moody (CA)

Correspondence Address: BRINKS HOFER GILSON & LIONE, P.O. BOX 10395, CHICAGO, IL, 60610, US

(21) Appl. No.: 11/301,675

(22) Filed: Dec. 13, 2005

(51) Int. Cl. G10L 21/02

(52) U.S. Cl. 704/227

(57) ABSTRACT

A signal processing system for receiving digital information across a voice band detects digital information in a received signal and replaces it with generated noise. The system includes a detector, a controller, and a converter. The detector detects whether a received signal transmitted across a voice band includes voice signals or digital data. The controller processes voice signals and digital data, estimates a noise component of the received voice signals, and generates a noise signal when digital data is detected by the detector. The converter receives either a voice signal or a comfort noise signal and converts the input signal into an aural signal.

### BACKGROUND OF THE INVENTION

1. Technical Field

This invention relates to data transmission, and more particularly, to a system that transmits and receives data across a voice band.

2. Related Art

Wireless communication systems allow mobile users to communicate with other users through mobile communication systems. In some systems, digital information may be transmitted between communication systems during speech pauses. Upon detection of digital information, a receiving communication system may attenuate received audio signals while the digital information is processed.

When a communication system is located in a high noise environment, the attenuating process may be noticed by a user. Therefore, a need exists for an improved signal processing system.

### SUMMARY

A signal processing system receives digital information across a voice band. The system detects digital information and replaces it with a generated noise. The system includes a detector, a controller, and a converter. The detector detects whether a signal transmitted across a voice band includes voice signals or digital data. The controller processes voice signals and digital data, estimates noise that may affect received voice signals, and generates a noise signal when digital data is detected by the detector. The converter receives a voice signal or a noise signal and converts the input signal into an aural signal.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a partial block diagram of a wireless communication system.

FIG. 2 is partial block diagram of a communication system.

FIG. 3 is a partial block diagram of a signal processing system.

FIG. 4 is an alternate partial block diagram of a signal processing system.

FIG. 5 is a flowchart of a signal processing system.

### DETAILED DESCRIPTION OF THE PREFERRED EMBODIMENTS

A signal processing system may detect digital data included in a signal transmitted across a voice band (such as a frequency range that is used for the transmission of speech), and process the data. The system may covertly process the received digital data by generating a noise signal substantially similar to a noise signal that originates at a sending side and which may be modified by its transmission through a wired or wireless network (e.g., comfort noise), and sending this noise signal to a user while the digital data is processed. By detecting the digital data in the transmitted signal and replacing it with a noise signal generated on the receiving side, the signal processing system may improve a user's perception of an aural sound.

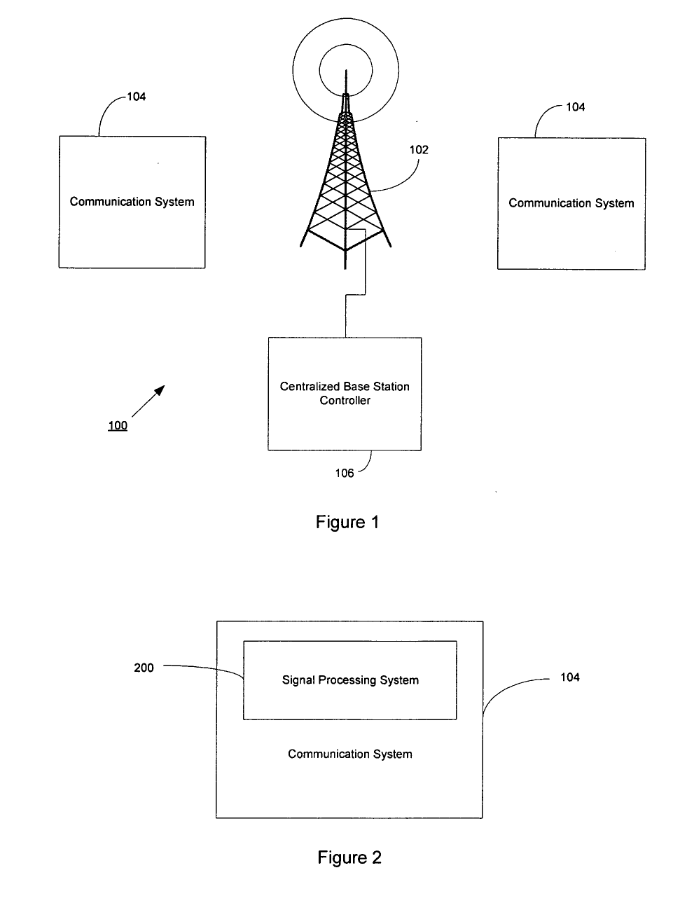

FIG. 1 is a block diagram of a wireless communication system 100. The wireless communication system 100 comprises a plurality of base stations 102 (one shown) that are fixed in particular locations, a centralized base station controller 106, and a plurality of mobile communication systems 104. The centralized base station controller 106 provides control data to base stations 102, either wirelessly or through a wired connection, and mobile communication systems 104, and may perform call routing operations. The centralized base station controller 106 may route a call from a mobile communication system 104 to another mobile communication system in the same or another wireless communication system, to a landline telephone on a Public Telephone Switched Network (“PSTN”), or over a packet switched Internet Protocol (“IP”) network as a Voice over IP (“VOIP”) call.

Base stations 102 may be distributed across a vast geographical area. Each base station 102 may service a small geographical area and communicate with mobile communication systems 104 through a wireless protocol. The protocol may spread the bandwidth of a transmitted signal over a frequency spectrum, encoding each transmitted signal with a code, such as Code Division Multiple Access (“CDMA”). In other systems, different communication protocols may also be used.

Mobile communication systems 104 communicate with one or more base stations 102. The mobile communication system 104 may transition across wireless communication system's 100 service area and may initiate or terminate communication links with the base stations 102. The creation and/or termination of these communication links permit a telephone call in progress to continue as mobile communication system 104 moves between different base stations 102. Various conditions may be monitored to determine when a communication link should be transferred, created, and/or terminated; decisions may be based on a received signal strength (measured either at the mobile communication system, the base station, or both) or network resource management needs. While mobile communication system 104 is in communication with one or more base stations 102, voice and/or digital data may be transmitted through a frequency channel.

Mobile communication system 104 includes logic to sample audio signals from a user's voice. These audio signals may be converted into digital form using a device which may convert a continuously varying signal, such as sound or voltage, to a binary code. Some systems may use an analog-to-digital converter. The digitized voice signals may be encoded and modulated onto a carrier frequency that is wirelessly transmitted through an access protocol of wireless communication system 100. A communication device (mobile or fixed) receiving the transmitted signal includes or has access to hardware and/or software that may demodulate, decode, and/or convert the digitized voice signals into a continuously varying or analog signal. Digital data may comprise non-speech user specific information, such as Global Positioning Satellite location information; a mobile telephone number; or other user specific location or account information. The digital data may be transmitted during a speaking lull (e.g., a pause in a user's speech) by converting the data into digital values that correspond to the amplitude of voice signals. The conversion of the digital data may be done in such as way as to prevent other encoding devices in wireless communication system 100 or a communication device from corrupting the data. Additionally, the conversion process provides the ability to use the same transceiver and encoding circuitry to transmit and receive both voice signals and digital data over a voice band.

When a speaking lull is detected (e.g., a lack of voiced or unvoiced speech for a determined time period, such as about 300-500 ms), digital data may be transmitted across a voice band. Prior to transmitting the digital data, the mobile communication system 104 may transmit a control message to the destination device. The message may inform a destination device that digital data will be transmitted. The destination device may then acknowledge its receipt of the control message by sending an acknowledgement message back. The acknowledgement message may inform the source communication system to begin transmitting digital data.

Upon receipt of the transmitted signal, the receiving communication device may detect and validate the presence of digital data. After the digital data is detected, the receiving communication device generates a noise signal that is sent to the user while the digital data is processed. In some systems, comfort noise is sent to the user. The generated noise signal may have a similar amplitude and spectral shape or frequency response as noise signals sent by the transmitting communication device. The noise may be generated at the receiving communication device and may be based on earlier measured noise signals that have been detected or extracted from transmitted voice signals (e.g., from a portion of the transmitted signal lacking speech). The generated noise may comprise about the last 100 ms of a transmitted voice signal. If the time period for processing the digital data exceeds the length of a detected or extracted noise signal, all or a portion of the noise signal may be repeated until the digital data processing is complete. The generated noise signal may represent the noise signal as it came through the network, and may account for modifications to the originally transmitted signal resulting from its transmission through a wired or wireless network. These modifications may include changes to spectral shape or amplitude, or other factors affecting the original transmitted signal.

In some systems, the detected or extracted noise signal may be stored in the receiving communication device. As multiple noise signals are detected or extracted from received voice signals, statistical analysis may be performed, such as averaging the noise signals together, to account for variations in the noise at the sending side. Alternatively, a frequency compressed noise estimate, a gain factor, a shape factor, or a noise pattern number that may be used with a library of stored, predetermined noise patterns may be sent with the digital data to track a rise or fall in the noise level, or change in its spectral shape.

Wireless communication system 100 may also be configured to support battery powered portable sending and receiving devices or communication devices such as walkie-talkies, or other devices or networks using an access protocol. Aside from CDMA, other protocols may be used such as Time Division Multiple Access, Extended Time-Division Multiple Access, Frequency Division Multiple Access, Narrowband Advanced Mobile Phone Service, the IS-54 standard, the IS-95 standard, or Global System for Mobile Communications.

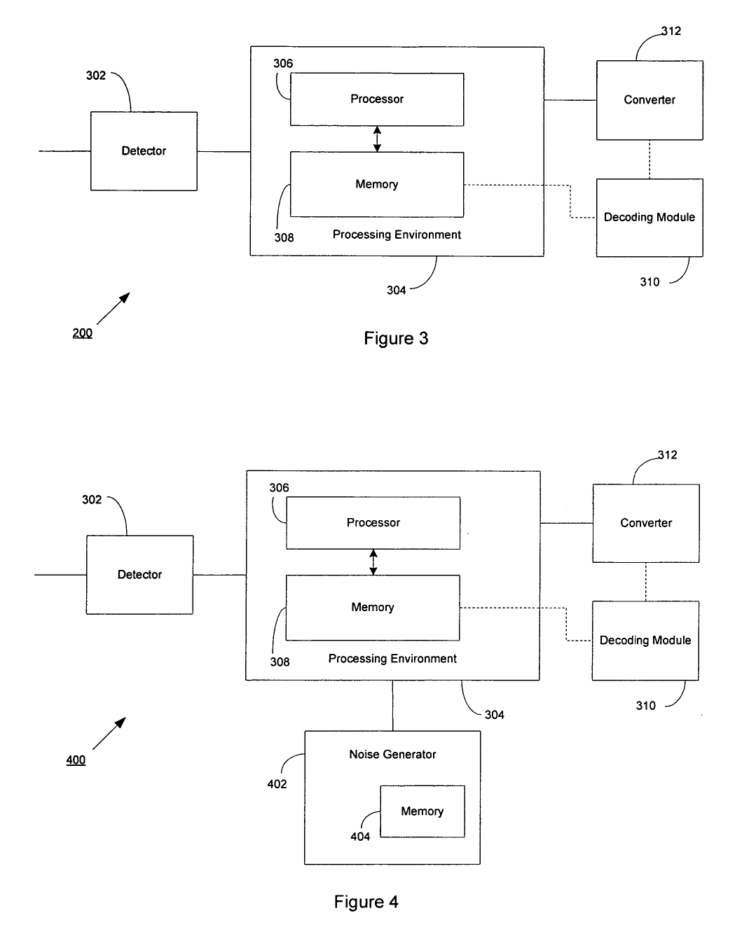

FIG. 2 is a partial block diagram of mobile communication system 104. Mobile communication system 104 comprises a signal processing system 200. Signal processing system 200 may be used to transmit and receive voice signals and digital data. In FIG. 3, a signal processing system 200 may include hardware and/or software that is capable of running on one or more processors using one or more operating systems. The signal processing system 200 receives a digital signal through a detector 302. Detector 302 analyzes the received digital signal for data content, and provides information to a processing environment such that the system may interpret the received signal.

The signal processing system 200 includes a processing environment 304, such as a controller or computer. The controller or computer 304 may include a processor 306 and a memory 308. The processor 306 may perform logic and/or control operations, track a speech noise level, and/or process digital data by accessing memory 308 via a bidirectional, serial, or parallel bus.

To track a speech noise level, memory 308 may store decoding logic or interface a decoding module 310 that converts a received digital signal to an analog signal. Some memory 308 may store buffered portions of analog voice signals obtained during the operation of signal processing system 200. The buffered portions of analog signals may comprise continuous noise that is substantially similar to the noise received from the sending side over a wired or wireless network. The buffered portions of received analog signals may be extracted from a determined portion of the received signal, such as the about last 100 ms of the transmitted signal. In addition to communicating with detector 302, processing environment 304 may communicate with converter 312.

Converter 312 may be an electromechanical device that receives an electrical signal and generates sound. The electrical energy signal may comprise a continuously varying signal and the sound may be perceived through converter 312. The input signal may be a decoded voice signal or a noise signal generated from the buffered portions of the received analog signal. Converter 312 may receive its input signal from processing environment 304 or decoding module 310.

FIG. 4 is an alternate signal processing system 400. The noise that exists at the sender's side may be mirrored by signal processing system 400 which may include a noise generator 402. Noise generator 402 may include memory 404. Memory 404 may include a library of noise patterns. In some systems, when the digital data is transmitted, a noise modeling characteristic, such as a pattern number, may be included with the transmitted signal. This pattern number may represent a noise spectrum stored within the library that is substantially similar to the noise spectrum on the sender's side. Processing environment 304 may detect or extract the noise pattern number from the received transmitted signal and send it to noise generator 402. Based on the pattern number, noise generator 402 may generate a noise signal that is sent to converter 312. In some systems, noise generator 402 may access processing environment's 304 memory 308 as opposed to having its own memory 404.

Alternatively, or in addition to the pattern number, the transmitted signal may include other noise modeling characteristics, such as a gain factor and/or one or more shape factors. The noise modeling characteristics may provide additional information that may be used to modify either the buffered data stored in processing environment 304 or the noise spectrums of the noise library.

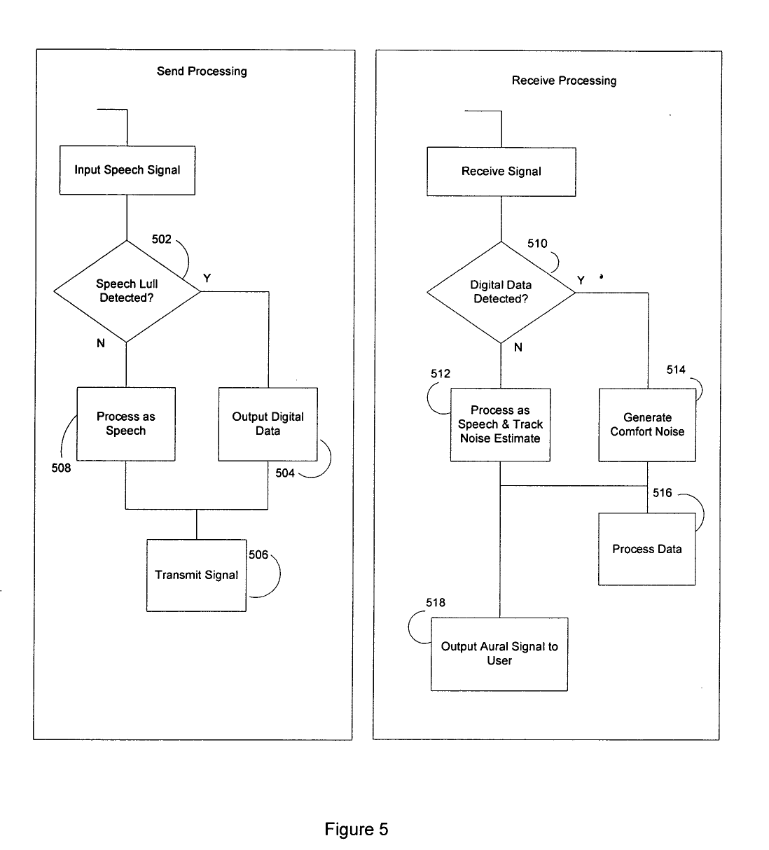

FIG. 5 is a flowchart of a signal processing system. The system may transmit and receive voice signals or digital data. In a transmitting mode, the system operates by analyzing a signal for a speech lull. When a speech lull is detected, the system may transmit digital data asynchronously or synchronously. When a speech lull is not detected, the system may transmit voice signals. In a receiving mode, the system operates by analyzing a signal for digital data. When digital data is detected, the system generates a noise signal substantially similar to the noise at the transmitting side, and processes the digital data while sending the noise signal through a converter. When digital data is not detected, the system processes the received voice signal and may estimate the noise component present at the sending side.

A speech signal may be received through an input device that receives voiced and unvoiced speech. The input device may convert the received signal into an electrical signal having an amplitude that varies with detected pressure changes. The input device may include a microphone. At act 502, the signal processing system analyzes the input signal to detect whether a speech lull exists. Some systems may use a noise estimator to detect a speech lull. The noise estimator may analyze the input signal to determine if the signal is substantially similar to a measured or detected noise signal. If the input signal and detected or measured noise signal are substantially similar for a determined time period, such as about 200 ms to about 300 ms, then a speech lull may be detected. A speech lull may be detected upon the origination of a phone call# at substantially the same time a receiving party answers the telephone call and before either party speaks.

Once a speech lull is detected, digital data may be transmitted across a voice band at acts 504 and 506. In some systems, the digital data may be converted into digital signals representing voice signals. In a digital format represented by voice-like signals, other signal processing devices may not attenuate the digital data prior to transmission. Prior to transmitting the digital data, the signal processing system may transmit a control message to a destination device. This message may inform the destination device that there is digital data to be transmitted. The destination device may acknowledge receipt of the control message by transmitting an acknowledgement. This acknowledgement may inform the signal processing system preparing to transmit the digital data to begin the transmission. To ensure high transmission rates, the data may be sent in substantially noise free packets.

When a speech lull is not detected at act 502, the signal processing system processes the input signal as speech at act 508. Processing of the speech may include converting the input signal to a digital signal through the use of an analog-to-digital converter, encoding the digital signal with a voice coder, and/or modulating the coded signal onto a carrier frequency. The modulated signal may be transmitted across a voice band at act 506. The modulated signal may be sent in full duplex (e.g., substantially simultaneous two-way communication) or half-duplex (e.g., two-way communication in one direction at a time).

A signal processing system receiving a transmitted signal analyzes a received signal at act 510 to determine if the signal contains digital data. In some systems, the existence of digital data is known to follow the transmission of the digital data control message. In these systems, the signal processing system receiving the transmitted signal may collect a determined length or number of packets of the transmitted signal and process it as digital data without confirming its digital encoded contents. Portions of the transmitted signal that exceed the determined length or number of packets are considered to be voice signals and processed accordingly.

At act 512 the signal processing system processes a transmitted voice signal and estimates a noise component of the voice signal. Processing of the transmitted voice signal may include demodulating and decoding the received signal, and performing a digital-to-analog conversion. To estimate the noise component of the transmitted voice signal, some systems may extract a determined portion of the transmitted signal and store this extracted portion in a memory. The extracted portion of the transmitted signal may comprise about 100 ms of a voiced segment. The system may extract any portion of the speech signal including an ending portion of the segment. Alternatively, each time a new extracted portion of the transmitted signal is processed, for a single phone call, a statistical analysis may be performed to account for variations in the noise signals. Statistical analysis may include averaging the newest portion of the transmitted signal with previous extracted portions of transmitted signals. This permits the noise estimate to vary as the phone call progresses.

If, at act 512, the signal processing system determines digital data is present in the transmitted signal, the system generates a noise signal, which may comprise comfort noise, at act 514. The noise generated at act 514 may comprise all or a portion of the noise signal estimated at act 512. The system may send the noise signal to a converter at substantially the same time the system is processing the digital data at act 516. The converter may be an electronic or electromechanical device that receives electrical energy and transmits an acoustic signal. The electrical energy may comprise an analog signal, and the acoustic signal may comprise an aural signal substantially similar to the noise that is heard or perceived at the sender's side. If necessary, the system may repeat all or a portion of the noise signal to substantially or entirely occupy the time period during which the digital data is processed. The converter may output sound energy at act 518.

Some signal processing systems are capable of alternative methods for transmitting and detecting voice signals and/or digital data. At act 504, a signal processing system preparing to transmit voice signals or digital data may add information about the transmission to the signal to be transmitted. This additional information may be added to any portion of the signal to be transmitted, including the beginning or end of the signal. Additional information added to the beginning of the signal to be transmitted may comprise header information. Header information may indicate whether the signal contains voice signals or digital data. Additionally, if the signal contains digital data, the header information may include noise modeling characteristics such as a noise pattern number, a gain factor and/or one or more shape factors. When a signal processing system determines whether a received signal contains digital data, at act 510, it may examine the additional information such as the header information or information in other segments of the signal.

When it is determined that digital data is included in the transmitted signal, the system may detect and/or extract noise modeling characteristics, if present. This information may be used at act 514 to generate the noise signal. The noise pattern number may correspond to one of a plurality of noise patterns that may be stored within the signal processing system. The signal processing system receiving the noise pattern number may select the appropriate noise pattern and provide the corresponding signal pattern as input to a converter. Additionally, the signal processing system may use noise modeling characteristics to modify a stored noise pattern and/or a detected and/or extracted portion of received voice signals that represent the noise at a sending side. The noise modeling characteristics may comprise information relating variations between the noise heard or perceived at the signal processing system transmitting the signal and the noise estimate signal at the signal processing system receiving the transmitted signal.

The method of FIG. 5 may be encoded in a signal bearing medium, a computer readable medium such as a memory, programmed within a device such as one or more integrated circuits, or processed by a controller or a computer. If the method is performed by software, the software may reside in a memory resident to or interfaced to the processing environment 304 or any type of communication interface. The memory may include an ordered listing of executable instructions for implementing logical functions. A logical function may be implemented through digital circuitry, through source code, through analog circuitry, or through an analog source such as through an electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A signal processing system, comprising:
a detector that detects digital data in a received signal transmitted across a voice band;
a controller that processes the received signal and generates a comfort noise signal; and
a converter coupled to the controller.

2. The system of claim 1, further comprising a memory coupled to the controller that stores a portion of the received signal when no digital data is detected.

3. The system of claim 2, where the stored portion of the received signal comprises a noise signal.

4. The system of claim 3, where the controller generates the comfort noise signal from all or a portion of the stored noise signal.

5. The system of claim 3, where the converter converts the comfort noise signal to an aural signal.

6. The system of claim 3, where the controller generates the comfort noise signal from a statistical analysis of a plurality of stored noise signals.

7. The system of claim 1, where the received signal comprises a noise modeling characteristic.

8. The system of claim 1, where the received signal comprises a first noise modeling characteristic and a second noise modeling characteristic.

9. The system of claim 7, where the controller uses the noise modeling characteristic to generate the comfort noise signal.

10. The system of claim 9, where the noise modeling characteristic comprises a gain factor.

11. The system of claim 9, where the noise modeling characteristic comprises one or more shape factors.

12. The system of claim 9, where the noise modeling characteristic comprises a noise pattern number.

13. A signal processing system, comprising:
means for detecting digital data in a received signal transmitted across a voice band; and
means for modeling a comfort noise signal corresponding to the received signal when no digital data is detected;

14. A method of receiving digital data, comprising:
detecting digital data in a received signal transmitted across a voice band;
generating a comfort noise signal at a receiving signal processing system based on an extracted portion of the received signal transmitted across a voice band that does not include digital data;
processing the digital data; and
converting the generated noise signal into an aural signal.

15. The method of claim 14, where the act of generating a comfort noise signal comprises extracting about 100 ms of the received signal that does not include digital data.

16. The method of claim 15, further comprising averaging the extracted portion of a the received signal, where the extracted portion of the received signal comprises a plurality of segments of the received signal transmitted across a voice band.

17. The method of claim 14, where the act of generating a noise signal comprises selecting a stored noise pattern.

18. The method of claim 17, further comprising modifying the selected noise pattern according to a noise modeling characteristic.

19. The method of claim 18, where the noise modeling characteristic comprises a gain factor.

20. The method of claim 18, where the noise modeling characteristic comprises a shape factor.

21. The method of claim 14, where the act of detecting digital data comprises analyzing a portion of the received signal.

22. A method of receiving digital data, comprising:
detecting digital data in a received signal transmitted across a voice band;
generating a comfort noise signal at a receiving signal processing system based on an extracted portion of a first received signal transmitted across a voice band that does not include digital data and a second received signal transmitted across a voice band that does not include digital data;
processing the digital data; and
converting the generated noise signal into an aural signal.

23. The method of claim 22, where the act of generating a comfort noise signal comprises performing a statistical analysis on the extracted portions of the received signals that do not include digital data.

24. A signal-bearing medium having software that generates a noise signal, comprising
a detector that detects digital data in a signal transmitted across a voice band;
a signal analysis logic that analyzes a portion of a previously transmitted voice signal
associated with the transmitted digital data signal.

25. The signal-bearing medium of claim 24, where the signal analysis logic analyzes a time duration after an absence of speech segment in the portion of a previously transmitted voice signal.

26. The signal-bearing medium of claim 25, where the signal analysis logic averages a plurality of time durations after an absence of speech sound in a plurality of previously transmitted voice signals.
